(19) United States
(12) Patent Application Publication
(10) Pub. No.: US 2012/0086189 A1
(43) Pub. Date: Apr. 12, 2012

(54) COLLAPSIBLE STRUCTURE FOR GOLF BAG CART

(75) Inventor: MENG-JUNG WU, TAINAN CITY (TW)

(73) Assignee: YUANN TAY ENTERPRISE CO., LTD., TAINAN HSIEN (TW)

(21) Appl. No.: 12/900,664

(22) Filed: Oct. 8, 2010

(51) Int. Cl. B62B 1/04

(52) U.S. Cl. 280/651

(57) ABSTRACT

A collapsible structure for golf bag cart, which comprises a coupling seat for connecting with a golf bag cart; a turning seat pivoted on one flank of the coupling seat; a wheel pivotally mounted on bottom end of the turning seat; a fixer provided on bottom end of the other flank of the coupling seat. The middle segment of the fixer is pivoted on the coupling seat and having an elastic element put thereon and the top end thereof being rested on the coupling seat so that the fixer after turning can recover to its original position. Several positioning portion and a positioning block are respectively provided on the coupling seat and the fixer, whereby the turning seat can be positioned and stops its turning. The turning seat can be rotated to dispose the wheel on its top end so that handy transportation of golf bag cart can be achieved.

### BACKGROUND OF THE INVENTION

1. Field of the Invention

This invention relates to a collapsible structure for golf bag cart, more particularly to a collapsible structure for handy delivery or easy carrying-along and is simple in operation even for ordinary person.

2. Brief Description of the Prior Art

Golf, which belongs to one of outside sports, is commonly known as small white ball sport in which individual or team player(s), using different types of clubs, attempt to hit balls finally into the hole of green. Therefore, a golf player has to prepare several different clubs, and all the clubs are placed in a golf bag when he is heading toward the green, then the golf bag is put on a golf bag cart to be carried along by golf player easily.

However, the above golf bag cart is disadvantageous for transportation due to bulk volume. Hence, a suitable collapsible device has to be installed in such a manner that users can place the cart on car for easy carrying up to green.

In view of the above disadvantages happened in prior art, the inventor of this invention hereby proposes a novel collapsible structure for golf bag cart according to endless effort devoted to the improvement and research conducted on the product, based on his philosophy and spirit of pursuit in progress, as well as his professional knowledge, technology and experience accumulated for many years.

### SUMMARY OF THE INVENTION

The main object of this invention is to provide a collapsible structure for golf bag cart, comprising a coupling seat for connecting with a golf bag cart; a turning seat pivoted to the coupling seat which is constructed for pivotally mounting a wheel, thereby the turning seat can be rotated to put the wheel on the top end thereof so that the purpose of handy transportation or easy carrying-along of golf bag cart can be achieved. Moreover, as the structure is also simple in operation even for ordinary person, remarkable industrial availability is relatively obvious.

In order to achieve above object, a collapsible structure for golf bag cart is provided in this invention, comprising a coupling seat for connecting to a golf bag cart; a wheel pivotally mounted on bottom end of a turning seat which is pivoted to one flank of said coupling seat; a fixer provided at the other flank of the coupling seat, the middle segment of the fixer being pivoted to the coupling seat and having an elastic element put thereon, the top end of which is rested on the coupling seat; a positioning portion and a positioning block respectively provided on the turning seat and the fixer, whereby the turning seat can be positioned and stops its turning.

### BRIEF DESCRIPTION OF THE DRAWINGS

FIG. 1 is a schematic view showing the collapsible structure of the present invention assembled on golf bag cart.

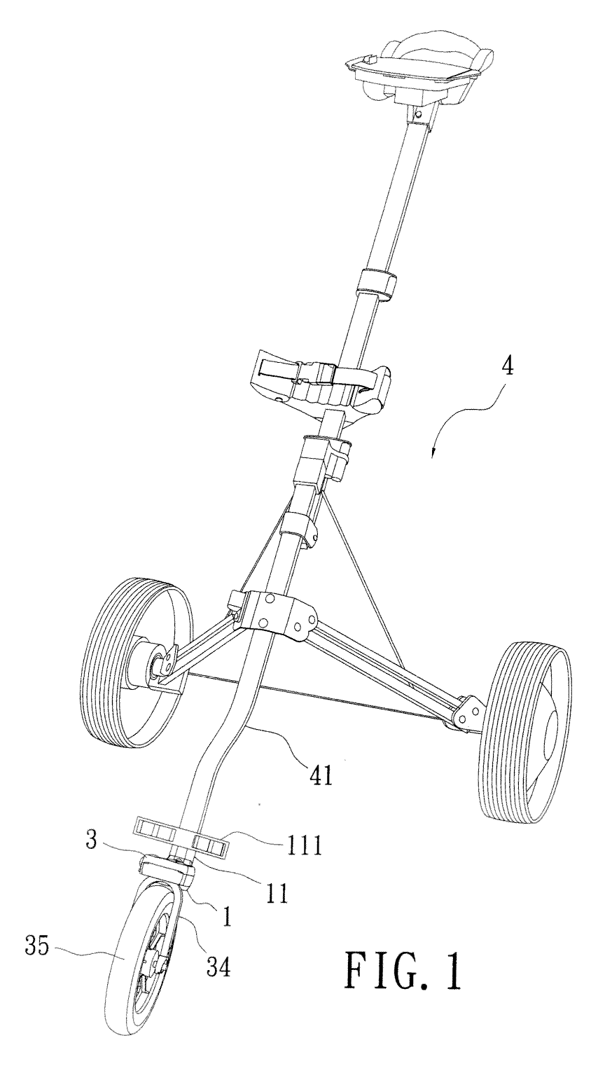

FIG. 2 is a perspective exploded view of the present invention.

FIG. 3 is a perspective assembled view of the present invention.

FIG. 4 is a sectional assembled view of the present invention.

FIG. 5 is a sectional view showing the turning state of the turning seat of the present invention.

FIG. 6 is a perspective view showing the turning state of the turning seat of the present invention.

FIG. 7 is an enlarged view showing the turning state of the turning seat of the present invention.

FIG. 8 is a perspective view showing the state of wheel collapsing of the present invention.

FIG. 9 is an enlarged view showing the state of wheel collapsing of the present invention.

### DETAILED DESCRIPTION OF PREFERRED EMBODIMENTS

The objects, the technical contents and the expected effect of the present invention will become more apparent from the detailed description of the preferred embodiment in conjunction with the accompanying drawings.

This invention relates to a collapsible structure for golf bag cart, which essentially has a coupling seat (1), a fixer (2) and a turning seat (3).

The coupling seat (1) has a holding jacket (11) provided vertically on the top end of its front side for connecting with a wheel main stem (41) of a golf bag cart (4). Further, a lower bracket (111) is horizontally attached to the rear side of the holding jacket (11), which is provided for stable close-contact with the bottom end of the golf bag. A through hole (12) is provided on a flank of the coupling seat (1) for pivotal mounting of the turning seat (3). A cut-out portion (13) is formed on bottom end of the front side of the coupling seat (1) for mounting the fixer (2), and a hole (14) is provided on the wall of the rear side of the cut-out portion (13). The fixer (2) penetrates through the hole (14) in such a manner that the turning seat (3) is positioned thereon. Further, a protection cover (15) is correspondingly provided at the cut-out portion (13) for protecting the fixer (2). A force-applying block (16) is formed on the flank of the coupling seat (1) for pulling the fixer (2) to move. A top stopper (17) corresponding to the fixer (2) is pivoted in the cut-out portion (13) for positioning the fixer (2).

A pivot shaft (21) penetrates through the middle segment of the fixer (2), which is pivoted in the cut-out portion (13) of the coupling seat (1). An elastic element (22) is put on the pivot shaft (21) so that the pivot shaft (21), after rotation, can be recovered to its original position. A positioning block (23) is connected to one end of the fixer (2), which can achieve the positioning of the turning seat (3). A snap socket (231) and a snap stud (24) mating with each other are respectively formed on the positioning block (23) and the fixer (2). A force-applying lever (25) for easy operation is provided on the other end of the fixer (2).

A bore (31) corresponding to the through hole (12) of the coupling seat (1) is provided on the flank of the turning seat (3), and a pivot member (32) for pivoting in the through hole (12) is provided within the bore (31). A plurality of positioning portion (33) corresponding to the positioning block (23) of the fixer (2) is formed on one side of the through hole (12), which cooperates with the positioning block (23) to achieve positioning and stops is turning. A fork rod (34) for mounting wheel is fixed on the bottom surface of the turning seat (3), and a wheel (35) is pivotally mounted on the bottom end of the fork rod (34). Furthermore, a limit block (6) is provided at the other side of the through hole (12) for limiting the rotation angle of the turning seat (3).

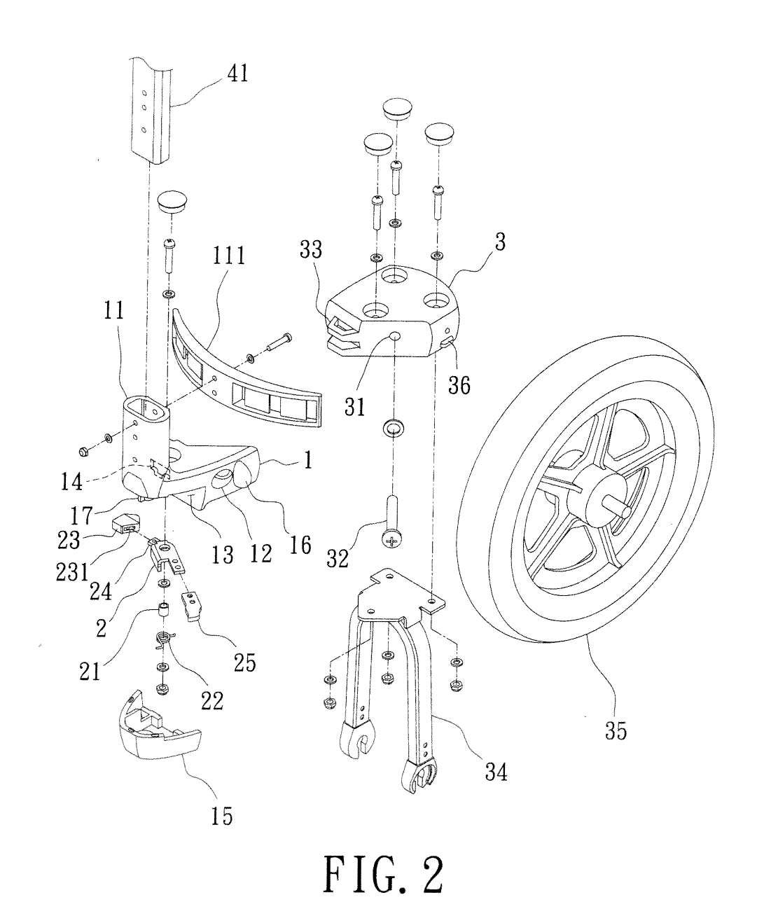

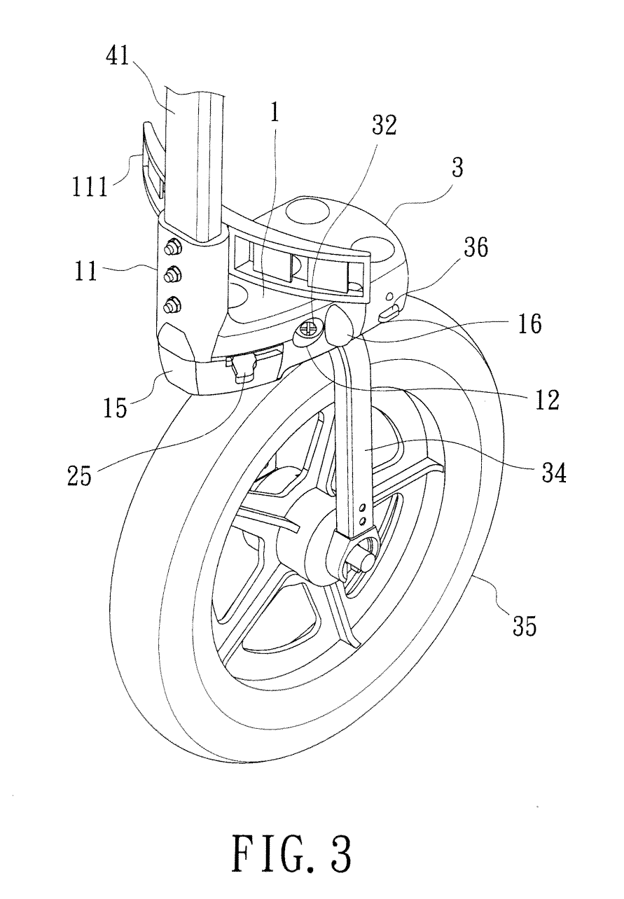

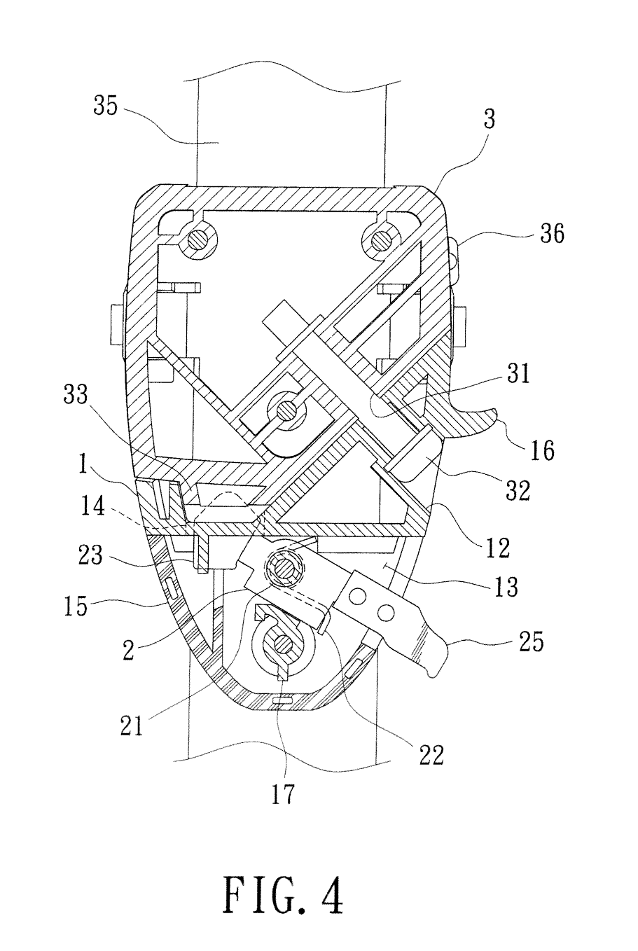

In assembly operation, referring to FIGS. 2 to 4, the pivot shaft (21) at the middle segment of the fixer (2) is pivoted in the cut-out portion (13) of the coupling seat (1) and is rested against to the flank of the top stopper (17). Then, the protection cover (15) is covered on the outside of the fixer (2), and the positioning block (23) of the fixer (2) and the force-applying lever (25) are respectively extended out from the hole (14) and between the cut-out portion (13) and the protection cover (15). The pivot member (32) of the turning seat (3) is pivoted within the through hole (12) of the fixer (2), and each positioning portion (33) is correspondingly engaged with the positioning block (23) of the fixer (2) so that the wheel (35) can be mounted on the bottom end for ready use.

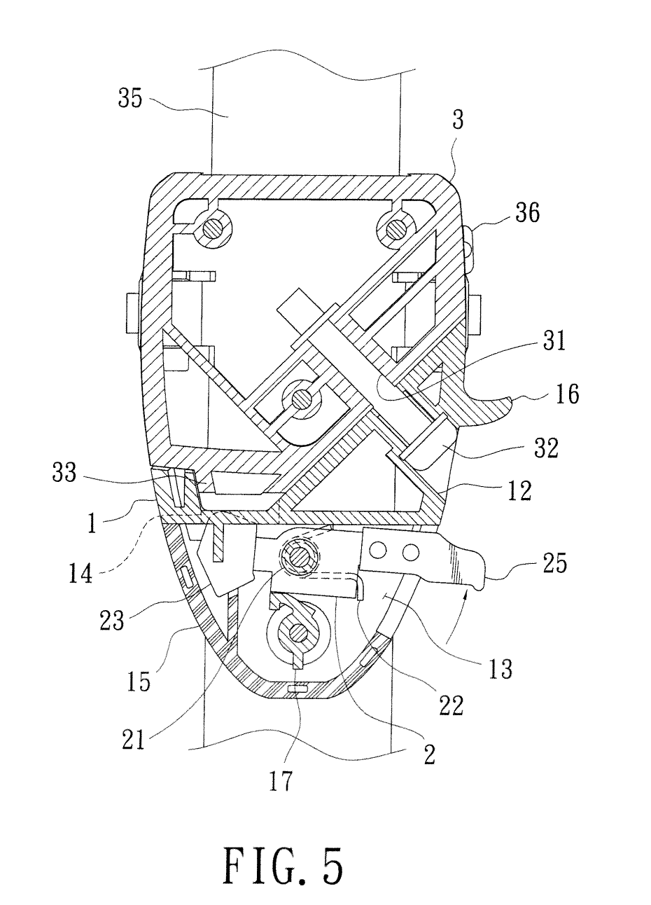

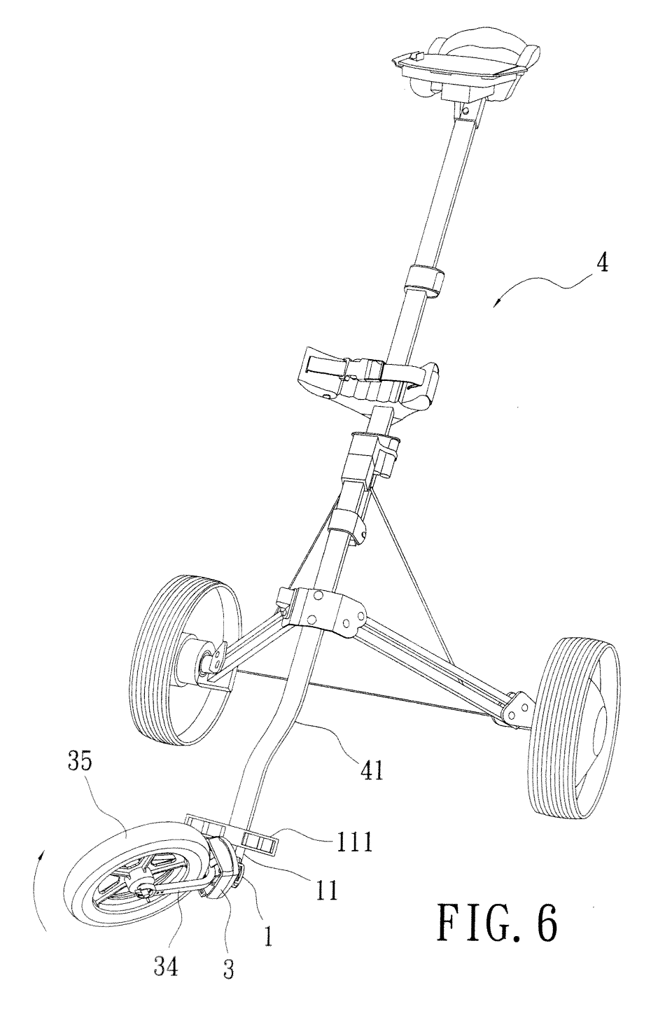

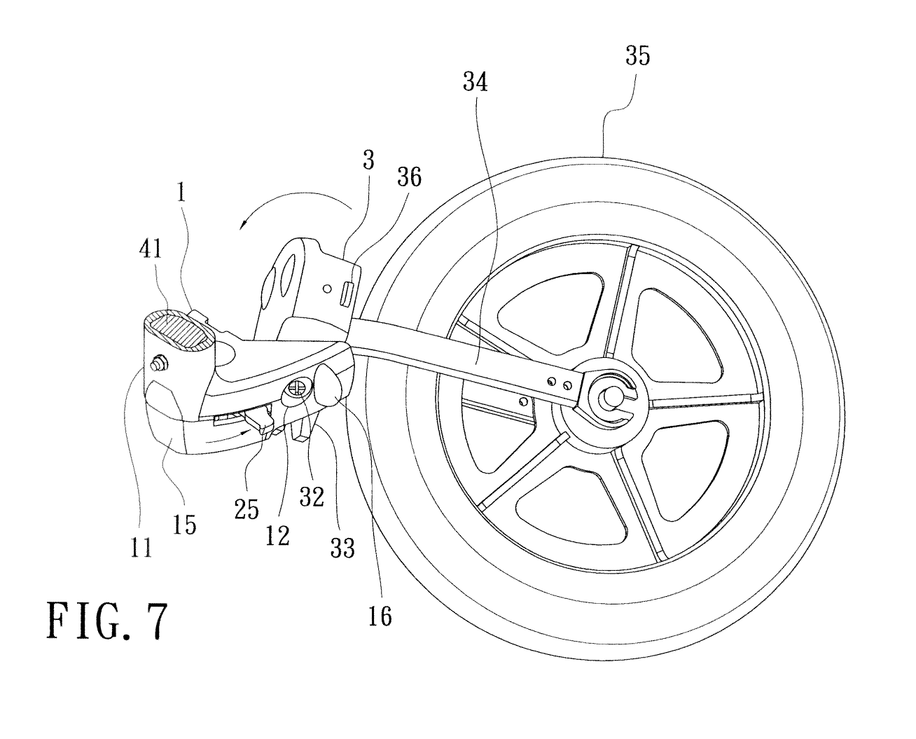

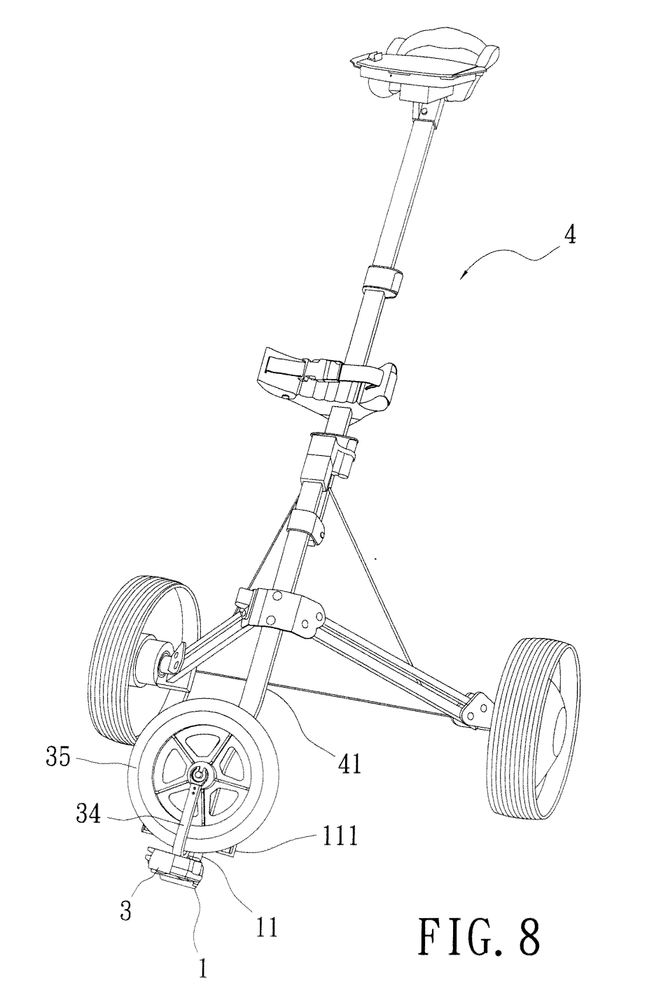

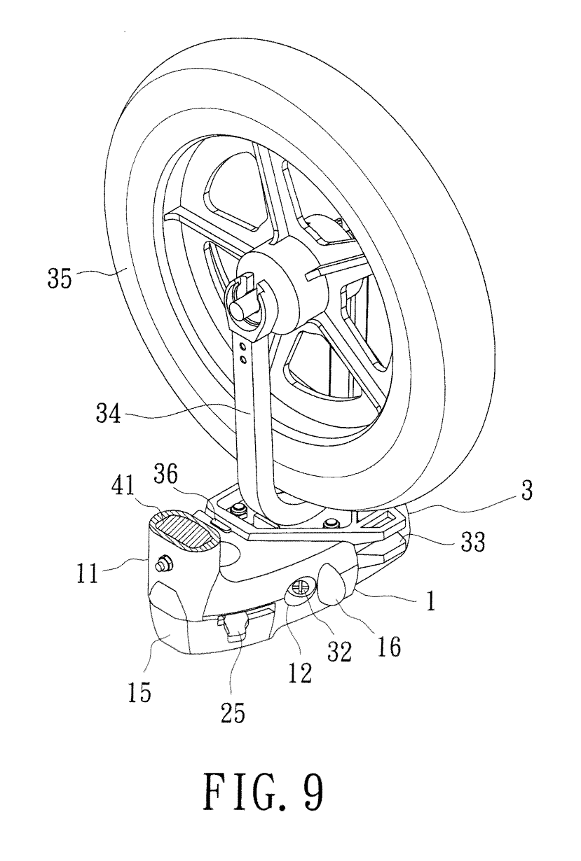

When the golf bag cart is to be collapsed, referring to FIG. 5, merely the force-applying lever (25) of the fixer (2) needs to be pulled so that the positioning block (23) is detached from each of the positioning portion (33), referring to FIGS. 6 and 7, then the turning seat (3) can be rotated to turn the wheel (35) upward. In this manner, referring to FIGS. 8 and 9, the limit block (36) is snap-fitted on the coupling seat (1) so that the wheel (35) can be collapsed to be disposed on the top end of the turning seat (3). Accordingly, the object of handy transportation or easy carrying-along of golf bag cart (4) can be achieved. Therefore, this invention does have remarkable industrial availability.

However, the above embodiments or drawings are not intended to limit the product aspect, pivot structure or usage mode of the present invention. Many modifications and variations of the present invention are possible in the light of the above teachings. It is therefore to be understood that within the scope of the appended claims, the invention may be practiced otherwise than what is specifically described by those skilled in this art.

It is understood from the element constitution and the implementation description that this invention has the following advantages comparing to the prior art.

1. In this invention, a coupling seat is provided to connect the golf bag cart. A turning seat pivoted on the coupling seat is for the pivotal mounting of a wheel. With this structure, the turning seat can be rotated so that the wheel can be collapsed to be disposed on the top end of the turning seat. Accordingly, the object of handy transportation or easy carrying-along of golf bag cart can be achieved. Therefore, this invention does have remarkable industrial availability.

2. In this invention, merely the force-applying lever of the fixer needs to be pulled so that the positioning block is detached from the positioning portions. Then, the turning seat can be rotated to turn the wheel upward so as to be disposed on the top end of the turning seat. The operation is very easy even for ordinary person.

What is claimed is:

1. A collapsible structure for golf bag cart, comprising a coupling seat for connecting to a golf bag cart; a wheel pivotally mounted on the bottom end of a turning seat which is pivoted on one flank of said coupling seat; a fixer provided at the other flank of said coupling seat, the middle segment of said fixer being pivoted on said coupling seat and having an elastic element put thereon, the top end of said elastic element being rested on said coupling seat; several positioning portions and a positioning block being respectively provided on said turning seat and said fixer, whereby said turning seat can be positioned and stops its turning.

2. The collapsible structure for golf bag cart as claimed in claim 1, wherein said coupling seat is formed with a cut-out portion which houses said fixer; a protection cover corresponding to said cut-out portion being provided to the outside of said fixer.

3. The collapsible structure for golf bag cart as claimed in claim 2, wherein said cut-out portion has a hole and said positioning block penetrates out of said hole to cooperate with said positioning portions.

4. The collapsible structure for golf bag cart as claimed in claim 2, wherein said cut-out portion is provided with a top stopper which is rested against said fixer.

5. The collapsible structure for golf bag cart as claimed in claim 1, wherein a limit block is provided at the other side of said turning seat corresponding to said positioning portions for limiting the turning angle of said turning seat.

6. The collapsible structure for golf bag cart as claimed in claim 1, wherein a snap socket and a snap stud mating with each other are formed between said positioning block and said fixer.
